(19) United States
(12) Patent Application Publication
(10) Pub. No.: US 2017/0109505 A1
(43) Pub. Date: Apr. 20, 2017

(54) INFORMATION PROCESSING DEVICE, INFORMATION PROCESSING METHOD, AND CONTENT SHARING SYSTEM

(71) Applicant: SONY CORPORATION, TOKYO (JP)

(72) Inventor: MASASHI NAKATA, KANAGAWA (JP)

(21) Appl. No.: 15/317,964

(22) PCT Filed: May 1, 2015
(86) PCT No.: PCT/JP2015/063121

§ 371 Date: Dec. 11, 2016

(30) Foreign Application Priority Data
Jul. 3, 2014 (JP) 2014-137530

(51) Int. Cl. G06F 21/10; H04L 29/06

(52) U.S. Cl. CPC G06F 21/10; H04L 63/10; G06F 2221/0731

(57) ABSTRACT

[Object] To enable information sharing of access-controlled content also with a user not having a use right becomes possible. [Solution] There is provided an information processing device including: a processing part adapted to, on a basis of a content sharing instruction from a user having a use right of content provided with the use right, place a use restriction to provide the content to a user not having the use right of the content.

### CROSS REFERENCE TO RELATED APPLICATIONS

This application is a U.S. National Phase of International Patent Application No. PCT/JP2015/063121 filed on May 1, 2015, which claims priority benefit of Japanese Patent Application No. JP 2014-137530 filed in the Japan Patent Office on Jul. 3, 2014. Each of the above-referenced applications is hereby incorporated herein by reference in its entirety.

### TECHNICAL FIELD

The present disclosure relates to an information processing device, an information processing method, and a content sharing system.

### BACKGROUND ART

Along with the wide spread of chat and social networking services (SNSs), information sharing has been facilitated between or among users, and they have been used as new communication forms. For example, Patent Literature 1 proposes a method for allowing multiple users to simultaneously reproduce the same music in a chat system.

### CITATION LIST

### Patent Literature

Patent Literature 1: JP 2010-205278A

### SUMMARY OF INVENTION

### Technical Problem

However, pieces of content such as music include access-controlled ones such as copyrighted works. To use such pieces of content, it is necessary to pay considerations to acquire corresponding use rights. For this reason, at the time of sharing of access-controlled content between or among users, a user having a use right has been able to share the content, but has been unable to share the content with a user not having the use right.

Therefore, it has been demanded to allow information sharing of access-controlled content also with a user not having a use right.

### Solution to Problem

According to the present disclosure, there is provided an information processing device including: a processing part adapted to, on a basis of a content sharing instruction from a user having a use right of content provided with the use right, place a use restriction to provide the content to a user not having the use right of the content.

According to the present disclosure, there is provided an information processing method including: placing, on a basis of a content sharing instruction from a user having a use right of content provided with the use right, a use restriction to provide the content to a user not having the use right of the content.

According to the present disclosure, there is provided a content sharing system including: multiple information processing terminals for using content; and a delivery server adapted to deliver content to the information processing terminals. On a basis of a content sharing instruction that is received from one of the information processing terminals and is from a user having a use right of content provided with the use right, the delivery server places a use restriction to provide the content to a user not having the use right of the content.

### Advantageous Effects of Invention

As described above, according to the present disclosure, information sharing of access-controlled content also with a user not having a use right becomes possible. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram explaining a configuration example of a content sharing system according to a first embodiment of the present disclosure.

FIG. 2 is a functional block diagram illustrating the functional configuration of the content sharing system according to the same embodiment.

FIG. 3 is a flowchart illustrating an example of a content sharing process in the content sharing system according to the same embodiment.

FIG. 4 is an explanatory diagram explaining the situation of sharing music content when users are chatting with each other.

FIG. 5 is an explanatory diagram explaining the sharing of music content during a voice call.

FIG. 6 is an explanatory diagram explaining that as an example of a qualitative restriction, respective frames constituting the movie content are thinned to perform provision.

FIG. 7 is an explanatory diagram explaining a method for providing a three-dimensional image as a two-dimensional image.

FIG. 8 is an explanatory diagram explaining that together with content to be shared, information not directly related to the content is presented in combination.

FIG. 9 is an explanatory diagram explaining that content having a use restriction is presented with a processing speed at which the content is provided being made lower than that at which the content is provided to a user having a use right.

FIG. 10 is a flowchart illustrating a process to change a reproduction method as an example of a qualitative restriction on music content.

FIG. 11 is an explanatory diagram illustrating the process to change the reproduction method as the example of the qualitative restriction on the music content.

FIG. 12 is a functional block diagram illustrating the functional configuration of a content sharing system according to a second embodiment of the present disclosure.

FIG. 13 is a hardware configuration diagram illustrating the hardware configuration of the delivery server according to the above embodiment of the present disclosure.

### DESCRIPTION OF EMBODIMENTS

Hereinafter, preferred embodiments of the present disclosure will be described in detail with reference to the appended drawings. In this specification and the appended drawings, structural elements that have substantially the same function and structure are denoted with the same reference numerals, and repeated explanation of these structural elements is omitted.

Note that the description will be given in the following order.

1. First embodiment (content process in information communication terminal)

### 1.1. Outline

1.2. Functional configuration
1.3. Content sharing process
1.4. Variation of use restriction information
(1) Available only during voice call
(2) Qualitative restriction (movie content)
(3) Insertion of information other than content
(4) Reduction in processing speed
(5) Qualitative restriction (music content)
2. Second embodiment (content process in cloud server)
2.1. Functional configuration
2.2. Content sharing process
3. Hardware configuration example

### 1. First Embodiment

### [1.1. Outline]

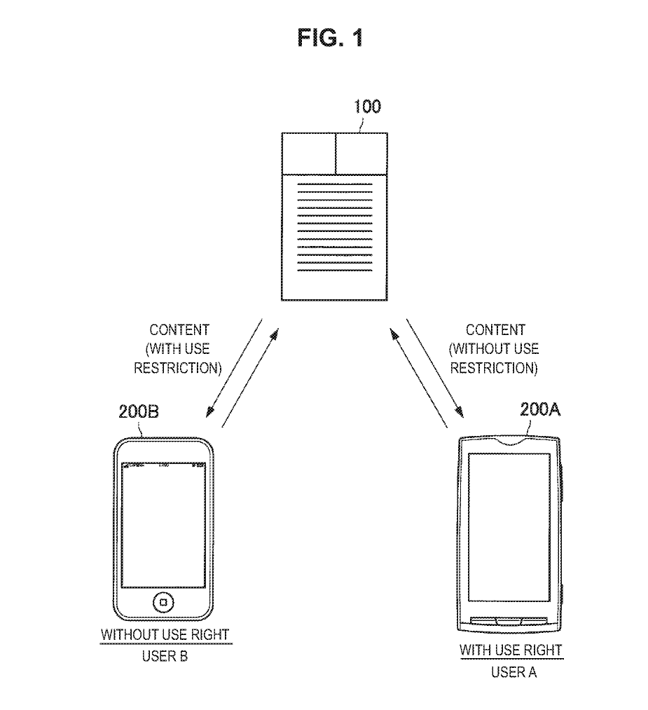

First, with reference to FIG. 1, the outline of a content sharing system according to an embodiment of the present disclosure will be described. FIG. 1 is an explanatory diagram explaining a configuration example of the content sharing system according to the present embodiment. Note that in the following, when not otherwise expressly stated, “content” refers to content that only a person having a right can use when using access control or the like.

The content sharing system according to the present embodiment is a system that when communicating between or among multiple users through a network, makes it possible to also share content between or among the users. In such a content sharing system, when the content to be shared has a use right, a method for providing the content is changed on the basis of whether or not each of the users has the use right of the content

For example, as illustrated in FIG. 1, it is assumed that a user having the use right of some piece of content and a user not having the use right are chatting using information communication terminals 200A and 200B such as smartphones. The information communication terminals 200A and 200B transmit/receive a message and the content through a delivery server 100. When the user A having the use right of the content desires to share the content with the user B not having the use right of the content, the user B not having the use right cannot use the content in a conventional manner.

Therefore, in order to make it possible to share the content also with the user B not having the use right, the content sharing system according to the present embodiment allows the user B not having the use right to use the content with restriction. That is, the user A having the use right can use the content without any restriction. On the other hand, the user B not having the use right is allowed to use the content while being subjected to a use restriction.

Such a mechanism makes it possible to share content between or among multiple users regardless of the use right of the content. Also, by making it possible for a user not having a use right to use the content with restriction, equity with a user who has paid a consideration to obtain the use right can be kept. In the following, the configuration and functions of the content sharing system according to the present embodiment will be described in detail.

### [1.2. Functional Configuration]

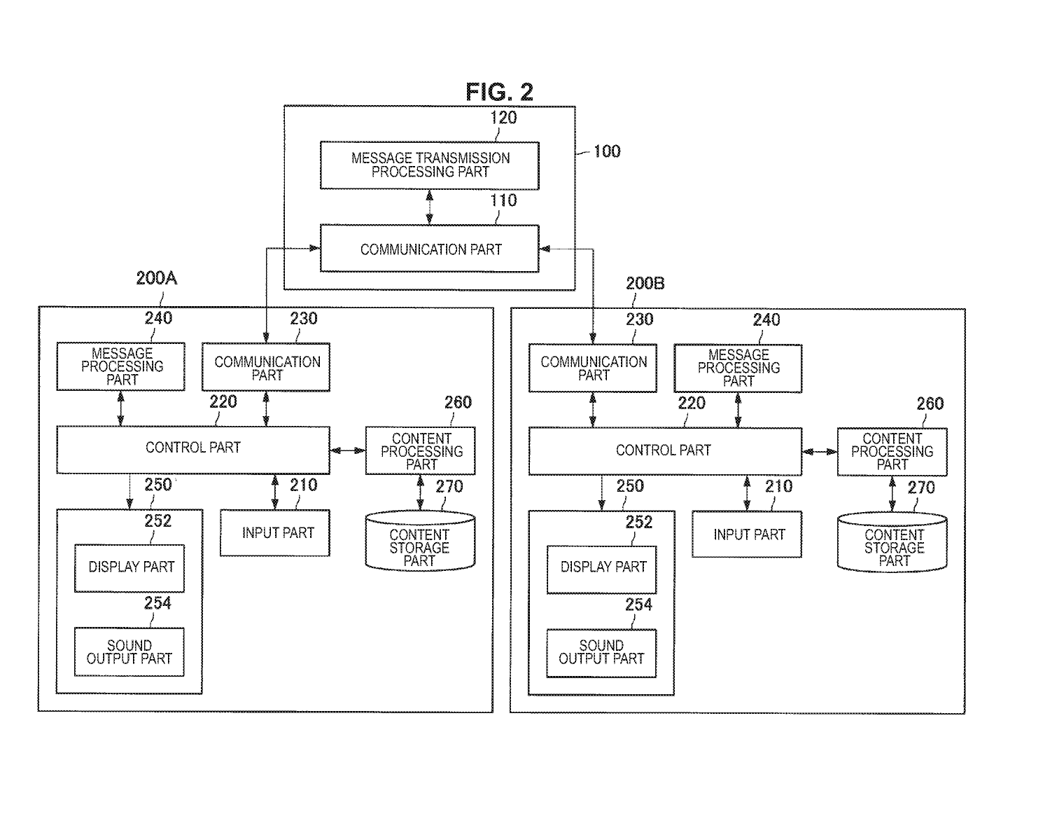

The functional configuration of the content sharing system according to the present embodiment will be described on the basis of FIG. 2. FIG. 2 is a functional block diagram illustrating the functional configuration of the content sharing system according to the present embodiment. In FIG. 2, it is assumed that the user using the first information communication terminal 200A has the use right of some piece of content, and the user using the second information communication terminal 200B does not have the use right of the content.

As illustrated in FIG. 2, the content sharing system according to the present embodiment is a system that makes it possible to transmit/receive messages between the two information communication terminals 200A and 200B through the delivery server 100. The messages may include voice messages like telephone calls and text messages such as mails and chat.

### (Delivery Server)

The delivery server 100 is a server adapted to deliver messages to the information communication terminals 200A and 200B connected through the network. The delivery server 100 also delivers content together with a message. As illustrated in FIG. 2, the delivery server 100 includes a communication part 110 and a message transmission processing part 120.

The communication part 110 is an interface adapted to transmit/receive information to/from the information communication terminals 200A and 200B connected through the network. The communication part 110 receives a message and/or content to be transmitted from each of the information communication terminals 200A and 200B to a transmission destination, and transmits the message and/or the content to an information communication terminal 200A or 200B as the transmission destination.

The message transmission processing part 120 performs a process to convert a message to be transmitted to a transmission destination into a transmittable form. After having processed the message received from the communication part 110, the message transmission processing part 120 transmits to an information communication terminal 200A or 200B as the transmission destination through the communication part 110.

### (Information Communication Terminal)

The information communication terminals 200A and 200B are terminals that the users use for transmitting/receiving a message and content, viewing content, or another purpose, and apparatuses such as mobile phones, smartphones, tablet terminals, or wearable terminals. In the present embodiment, the first information terminal 200A used by the user having the use right of content and the second information terminal 200B used by the user not having the use right of the content have the same configuration; however, the present technique is not limited to such an example. For example, a content processing part 260 and a content storage part 270 are ones that make it possible to hold content inside a terminal, and perform a content process in the terminal when providing the content to the other terminal, and when another apparatus performs the same process, the content processing part 260 and the content storage part 270 do not have to be included.

As illustrated in FIG. 2, the first information communication terminal 200A and the second information communication terminal 200B include an input part 210, a control part 220, a communication part 230, a message processing part 240, an output part 250, the content processing part 260, and the content storage part 270.

The input part 210 is a functional part adapted to receive an information input by a user, and implemented by, for example, a touch panel capable of detecting the touch or proximity of an operation body operated by the user, buttons, a keyboard, and the like. When enabling voice input, as the input part 210, a microphone and the like are provided. The user uses the input part 210 to input a message to be transmitted to the other user. Also, the user uses the input part 210 to designate content to be shared with the other user.

The control part 220 covers all aspects of control processing of functions of an information communication terminal 200A or 200B. The control part 220 transmits a message and/or content on the basis of information inputted from the input part 210, and outputs the information inputted from the input part 210, received information, or the like to the output part 250. Also, when sharing content with the other user not having the use right of the content, the content processing part 260 is made to perform a process to place a use restriction on the content.

The communication part 230 is an interface adapted to transmit/receive information to/from the delivery server 100 or an information communication terminal 200A or 200B connected through the network. The communication part 230 transmits a message inputted from the information communication terminal 200A (or 200B) and/or designated content to the delivery server 100. Also, the communication part 230 receives a message and/or content transmitted from the other information communication terminal 200B (or 200A) through the delivery server 100.

The message processing part 240 processes a message inputted from the input part 210 or a message received from the information communication terminal of the other user to convert the message into a form that enables output from the output part 250. The message processing part 240 processes the message upon receipt of an instruction of the control part 220. The processed message is outputted to the output part 250 through the control part 220.

The output part 250 is a functional part adapted to output information, and includes a display part 252 and a sound output part 254. The display part 252 is a functional part adapted to display information, and can be implemented by, for example, a liquid crystal display, an organic EL display, or the like. The sound output part 254 is a functional part adapted to output sound information, and can be implemented by, for example, a speaker or the like. Receiving the provision of a message and/or content from the output part 250 allows the user to share information with the other user.

When sharing content with the other user, the content processing part 260 performs the process to place a use restriction on the content. When using the content, the other user is adapted by the content processing part 260 to receive a predetermined restriction depending on the type of the content to be provided or a method for providing the content. Use restrictions on content include, for example, a temporal restriction that enables use only at the time of simultaneous use with the user having a use right, a qualitative restriction that reduces the quality of the content, and the like.

When being instructed by the user having the use right of content to share the content with the other user, the content processing part 260 acquires the content as a target from the content storage part 270 to add a use restriction to be placed on the content to the content as use restriction information. The content added with the use restriction information is transmitted to the delivery server 100 through the communication part 230, and then transmitted to the terminal of the other user.

The content storage part 270 is a storage part adapted to store pieces of content. The pieces of content include, for example, pieces of music, photographs, moving images, electronic books, games, and the like. The pieces of content stored in the content storage part 270 can be freely used by the user him-/herself, and also include pieces of content that the other user does not have any right to use. Content stored in the content storage part 270 is processed by the content processing part 260 as necessary, and then can be shared with the other user.

### [1.3. Content Sharing Process]

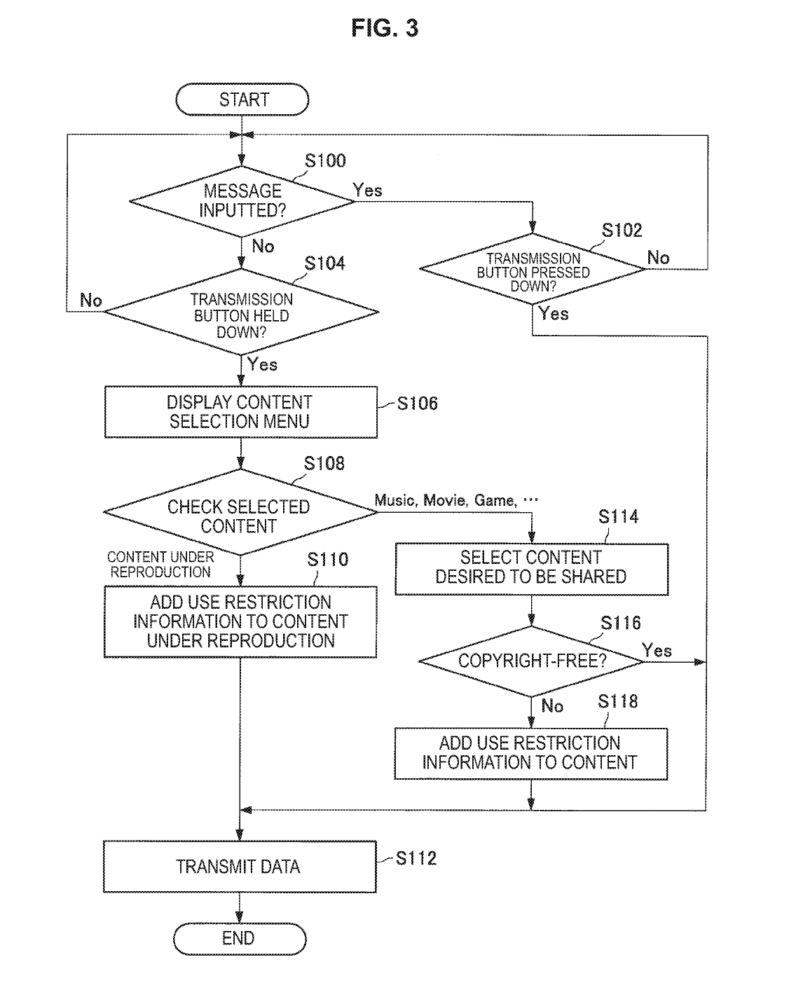

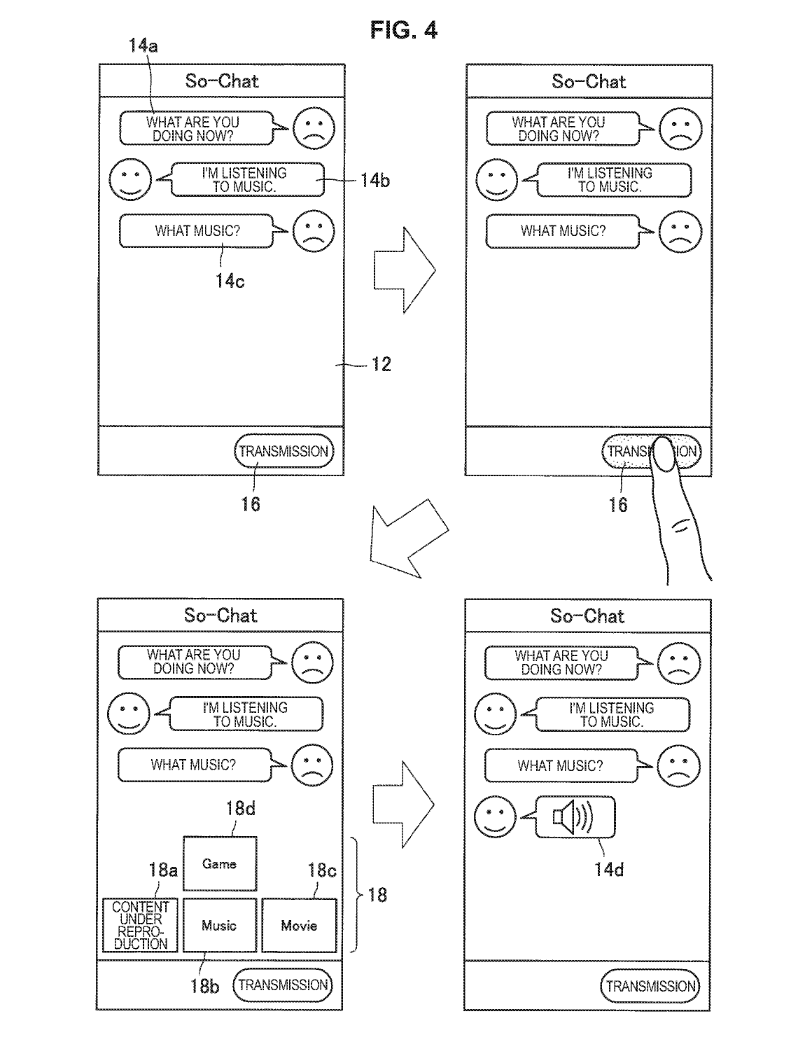

On the basis of FIG. 3 and FIG. 4, a content sharing process in the content sharing system according to the present embodiment will be described. FIG. 3 is a flowchart illustrating an example of the content sharing process in the content sharing system according to the present embodiment. FIG. 4 is an explanatory diagram explaining the situation of sharing music content when the users are chatting with each other. Note that the process illustrated in FIG. 3 is a process common to the information communication terminals 200A and 200B of the respective users who are chatting, and a process at the time of acting as a message transmitter is illustrated.

Here, as an example, the case of sharing the music content when the users are chatting with each other will be described. The music content is copyrighted content, and one that only the user who has paid a consideration to have a use right can use. As illustrated in the upper left of FIG. 4, it is assumed that on the display part 252 of the information communication terminal 200 such as a smartphone, a chat screen 12 is displayed. On the chat screen 12, a message (e.g., a message 14a or 14c) received from the other chat user and a message (e.g., a message 14b) inputted and transmitted to the other chat user by the user are alternately displayed.

In the content sharing system according to the present embodiment, the user as the message transmitter can attempt to share the content with the other chat user while chatting as described. As illustrated in FIG. 3, the control part 220 of the information communication terminal 200 used by the user attempting to transmit a message or content first checks whether or not a message has been inputted from the input part 210 (S100). When the message has been inputted, the control part 220 then determines whether or not a transmission button 16 (see FIG. 4) for transmitting the message has been pressed down (S102). Note that the transmission button 16 is one included in the input part 210 illustrated in FIG. 2.

When it is determined in Step S102 that the transmission button 16 is not pressed down, the processing steps from Step S100 are repeated. On the other hand, when it is determined in Step S102 that the transmission button 16 has been pressed down, the control part 220 transmits the message inputted in Step S100 to the delivery server 100 through the communication part 230 (S112). The delivery server 100 having received the message from the information terminal 200 performs a message transmission process, and then transmits the message to the information communication terminal 200 used by the other chat user.

Returning to the processing step in Step S100, when it is determined that no message is inputted from the input part 210, the control part 220 then determines whether or not the transmission button 16 has been held down (S104). The information communication terminals 200 according to the present embodiment are also capable of transmitting content in addition to messages that are usually transmitted/received through chat. In the present embodiment, a hold down operation of the transmission button 16 is related to a content selection menu display process for selecting content to be shared with the other chat user. Therefore, from the determination in Step S104, it is determined whether or not the user attempts to display a content selection menu.

That is, the processing step in Step S104 is for an operation to determine whether or not an operation to perform the content selection menu display process has been performed. Accordingly, as the operation to perform the content selection menu display process, an operation other than the hold down operation of the transmission button 16 may be related. In such a case, in Step S104, it is determined whether or not the operation to perform the content selection menu display process has been performed.

A time for determining the holding down of the transmission button 16 can be arbitrarily set, and may be set to, for example, approximately one second. When it is determined in Step S104 that the transmission button 16 is not held down, the processing steps from Step S100 are repeated. On the other hand, when it is determined in Step S104 that the transmission button 16 has been held down, the control part 220 displays the content selection menu on the display part 252 (S106). For example, as illustrated in the upper right of FIG. 4, in the case where the transmission button 16 has been held down for the predetermined time or more, as illustrated in the lower left of the same drawing, the content selection menu 18 is displayed, for example, in a space on the chat screen 12.

The content selection menu 18 may be configured to include, for example, a “Content under reproduction” button 18a, “Music” button 18b, “Movie” button 18c, and “Game” button 18d. When the “Content under reproduction” button 18a is selected, content under current reproduction is shared in the information communication terminal 200. Alternatively, when any of the “Music” button 18b, “Movie” button 18c, and “Game” button 18 d is selected, a list of pieces of target content stored in the content storage part 270 of the information communication terminal 200 may be displayed on the display part 252. After that, content selected by the user from the list of the pieces of content can be set as a sharing target.

Subsequently, the control part 220 checks the content selected through the content selection menu 18 (S108). When the selected content is the content under reproduction, the control part 220 makes the content processing part 260 add predetermined use restriction information to the content under reproduction (S110). Use restriction information is information representing a use restriction that is to be added when sharing content with a user not having a use right. Use restriction information is set depending on the type of content to be provided or a method for providing content. In the present embodiment, a temporal restriction is provided on the basis of the use restriction information, and only when the current chat is being connected, the content is made available.

When the use restriction information is added to the content to be shared, the control part 220 transmits the content and the use restriction information to the delivery server 100 through the communication part 230 to make the delivery server 100 transmit them to the information communication terminal of the other chat user (S112). When the content is transmitted, on the display part 252 of the information communication terminal 200, an icon message 14d for reproducing the shared content is displayed as illustrated in, for example, the lower right of FIG. 4. The icon message 14 may be adapted to be set depending on content. For example, when the music content is shared as illustrated in FIG. 4, a speaker icon is illustrated in the icon message 14d. This makes it possible to visually inform the other chat user of the type of the shared content.

When the user having received the icon message 14d presses down the icon message 14d, the content related to the icon message 14 is made available within a range prescribed in the use restriction information. For example, in the case of the music content, when pressing down the icon message 14, music starts to play. The present embodiment may be adapted such that on the basis of the use restriction information indicating that the content is available only while the current chat is being connected, it becomes impossible to press down the icon message 14 when the chat is ended.

Returning to the description of Step S108 in FIG. 3, when the content selected in Step S108 is other than the content under reproduction, the control part 220 presents a list of pieces of sharable content to the user to make the user select content desired to be shared with the other chat user (S114). When the user selects the content desired to be shared with the other chat user, the control part 220 makes the content processing part 260 check whether or not the selected content is copyright-free content (S116). That is, it is checked whether or not the content desired to be shared with the other chat user is content freely available to everyone.

In Step S116, in the case of the copyright-free content, the control part 220 transmits to the delivery server 100 through the communication part 230 without adding use restriction information to the content, and makes the delivery server 100 transmit to the information communication terminal 200 of the other chat user (S112). At this time, on the display part 252 of the information communication terminal 200 of the user having received the content, as described above, an icon message 14d for reproducing the shared content as illustrated in the lower right of FIG. 4 is displayed. When pressing down the icon message 14d, the user having received the icon message 14d can use the received content. Since the content is copyright-free, the content can be freely used even after the end of the chat.

On the other hand, in Step S116, when it is determined to be non-copyright-free content, the control part 220 adds the use restriction information to the content (S118), and transmits to the delivery server 100 through the communication part 230 to make the delivery server 100 transmit to the information communication terminal 200 of the other chat user (S112). In this case, the same process as that in Step S110 is performed. Accordingly, by pressing down an icon message 14d, the user having received the icon message 14d can use the content related to the icon message 14 within the range prescribed in the use restriction information.

In the above, the content sharing process in the content sharing system according to the present embodiment has been described. According to the present embodiment, when sharing content between or among multiple users, in particular, when sharing content having access control like a copyright with a user not having the use right of the content, a use restriction is placed to enable the sharing. In doing so, it becomes possible to share the content between or among the multiple users regardless of the use right of the content. Also, by allowing the user not having the use right to use the content with restriction, equity with a user who has paid a consideration to obtain the use right can also be kept

### [1.4. Variation of Use Restriction Information]

In the content sharing system according to the present embodiment, when sharing content with a user not having the use right of the content, use restriction information is added to restrict a range where the user not having the use right can use the content. In the above-described example explained on the basis of FIG. 3 and FIG. 4, the restriction that only while the current chat connection is being established, the content is available is added, however, the present technique is not limited to such an example. The contents of use restriction information can be appropriately set depending on the type of content to be shared or a method for providing content. In the following, the contents of use restriction information will be exemplified.

### (1) Available Only During Voice Call

As a situation where multiple users share content, for example, it is conceivable to share music content during a voice call. For example, while the music content is being reproduced as background music during a call, by reproducing the music content under reproduction also in a terminal of the other caller, an atmosphere of sharing space while listening to the music can be formed.

Note that when the other caller does not have the use right of the music content, the content processing part 260 adds use restriction information to the music content and transmits to the terminal of the other caller. In such a case, for example, use restriction information indicating that the music content is made available only during the call may be added.

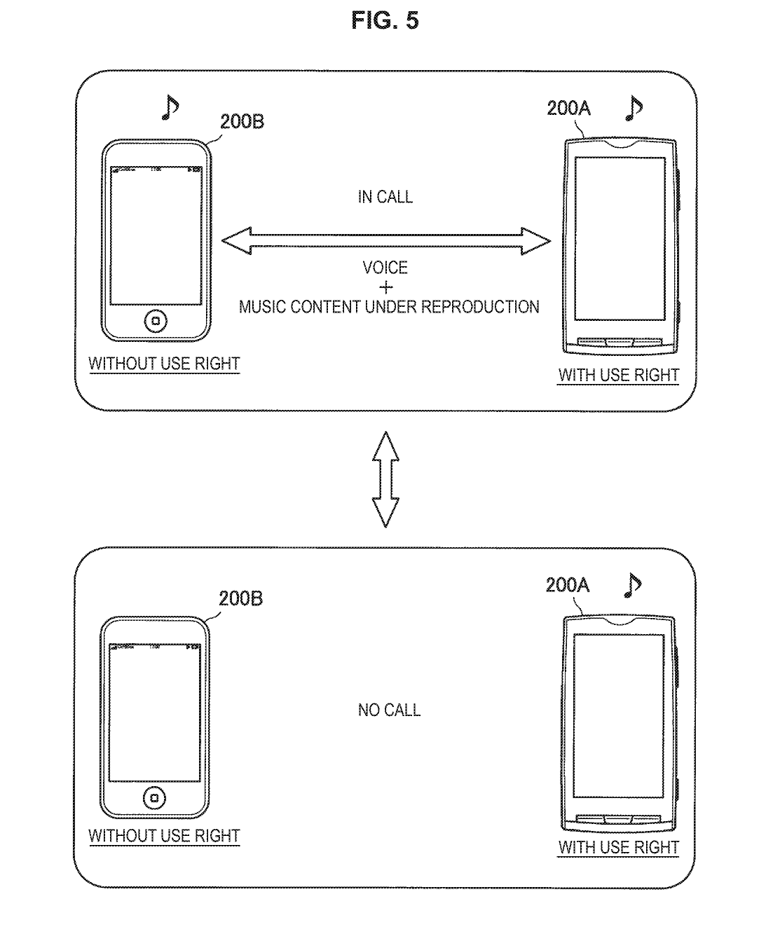

That is, as illustrated in the upper side of FIG. 5, when the call between the information communication terminals 200A and 200B is being established, the music content being reproduced by the information communication terminal 200A of the one user is transmitted to the information communication terminal 200B of the other user together with the voices of the respective users. During the call, the music content is made reproducible also in the information terminal 200B. On the other hand, as illustrated in the lower side of FIG. 5, when the call between the information communication terminals 200A and 200B is not established, the music content can be reproduced in the information communication terminal 200A having provided the music content. However, in the information communication terminal 200B having received the music content, it becomes impossible to reproduce the music content.

As described, for the information communication terminal 200B of the user side having been provided with the content, the use restriction information indicating that the use is enabled only simultaneously with the user having provided the content may be set.

### (2) Qualitative Restriction (Movie Content)

As content to be shared between the multiple users, in addition to the above-described music content, for example, movie content is also conceivable. In the case of the movie content as well, in the same manner as that described above, it may be adapted to add a temporal restriction that, in the information communication terminal 200B having been provided with the content on the side of the user not having the use right of the content, makes the content available only simultaneously with the user having provided the content. Alternatively, it is also conceivable to, when providing the movie content to the information communication terminal 200B on the side of the user not having the use right of the content, as use restriction information, add a qualitative restriction adapted to reduce the quality of the movie content.

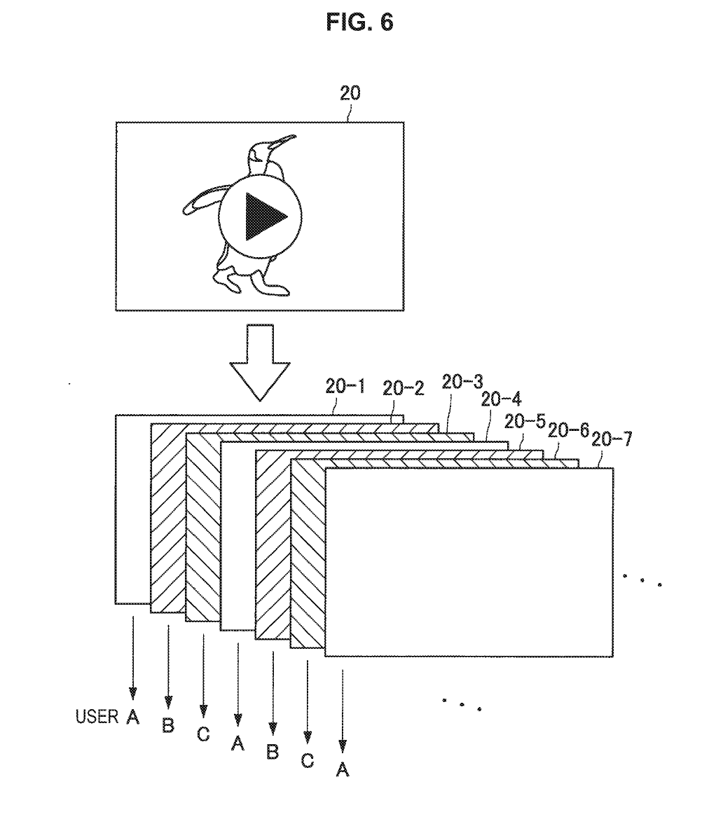

As an example of the qualitative restriction, it is conceivable to thin respective frames constituting movie content and then perform provision. For example, as illustrated in FIG. 6, it is assumed that movie content 20 is configured to include multiple frames 20-1, 20-2, 20-3, . . . . When a user having the use right of the movie content 20 shares the movie content 20 with users A, B, and C not having the use right, the content processing part 260 provides only parts of the frames to information communication terminals 200 of the users A, B, and C. For example, the content processing part 260 may be adapted to repeatedly allocate each frame in order of the users A, B, and C along a time series. In doing so, it becomes possible for the users A, B, and C not having the use right to also view the movie content 20 although quality is made lower than an original state.

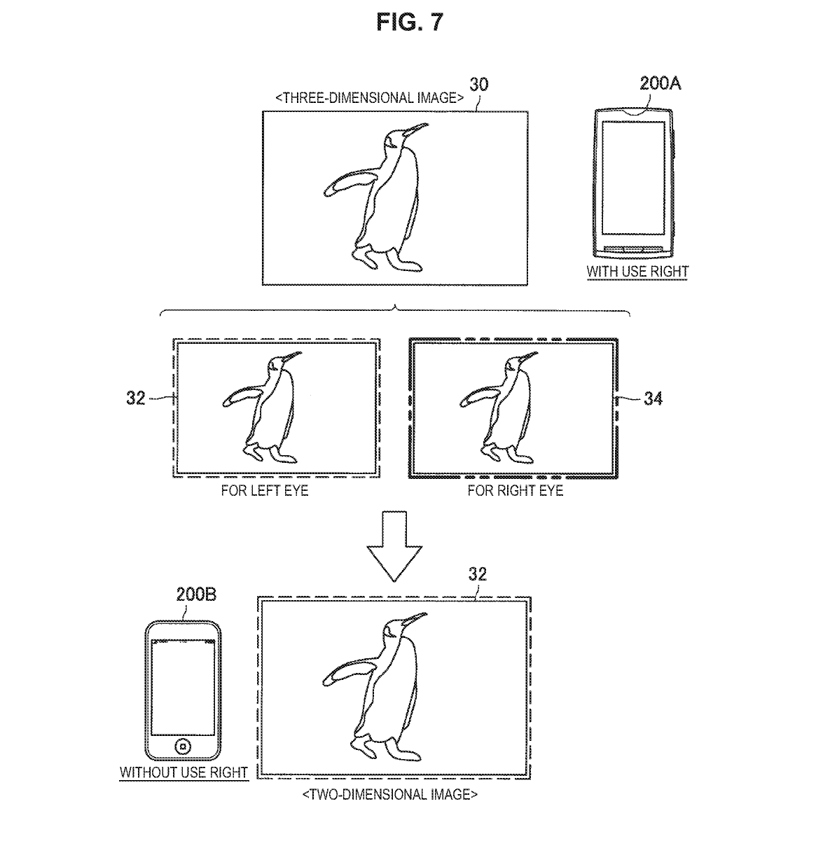

Also, it may be adapted such that when being a three-dimensional image, movie content 30 is provided as the three-dimensional image to the information communication terminal 200A of the user having the use right of the movie content 30 and provided as a two-dimensional image to the information communication terminal 200B of the user not having the use right. As a method for providing the three-dimensional image as the two-dimensional image, for example, as illustrated in FIG. 7, when the movie content 30 as the three-dimensional image is configured to include a two-dimensional image for left eye 32 and a two-dimensional image for right eye 34, it is conceivable to provide only any one of the two-dimensional images. As described, by providing a two-dimensional image constituting the three-dimensional image supposed to be provided to a user, it becomes possible for the user not having the use right to also view the movie content 30 although quality is made lower than an original state.

(3) Insertion of Information Other than Content

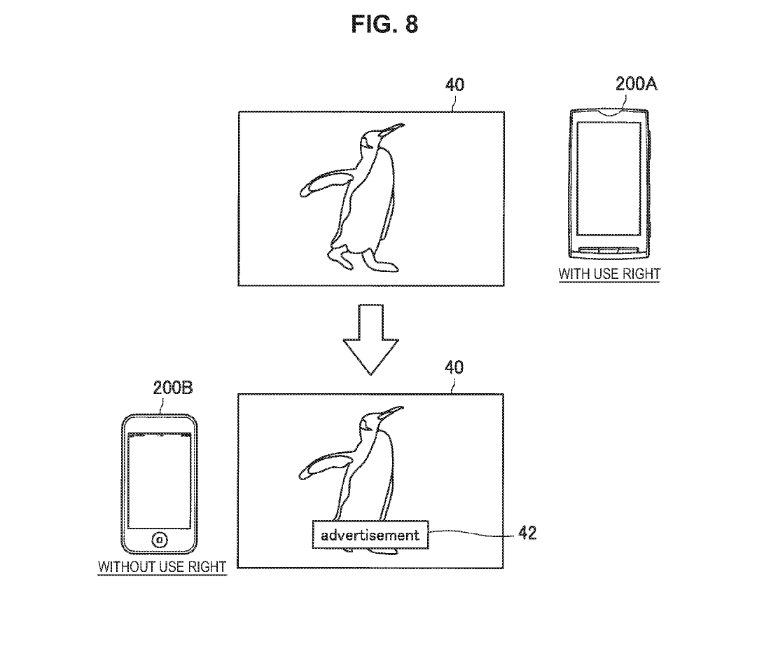

As use restriction information at the time when a user not having the use right of content uses the content, for example, it is also conceivable to, together with the content to be shared, present information not directly related to the content in combination. For example, as illustrated in FIG. 8, in the information communication terminal 200A of the user having the use right of movie content 40, only the movie content 40 is viewable. On the other hand, in the information communication terminal 200B of the user having been provided with the movie content 40 but not having the use right, information (such as an advertisement) 42 not directly related to the content is displayed superposed on the movie content 40. As described, due to the information 42 not directly related to the content, the user not having the use right cannot view part of the movie content 40, but can recognize the contents of the movie content 40.

### (4) Reduction in Processing Speed

Also, as use restriction information at the time when a user not having the use right of content uses the content, for example, it is also conceivable to make a processing speed at which the content to be shared is provided lower than that at which the content is provided to a user having the use right and then present the content. For example, it is assumed that the content to be shared is electronic book content.

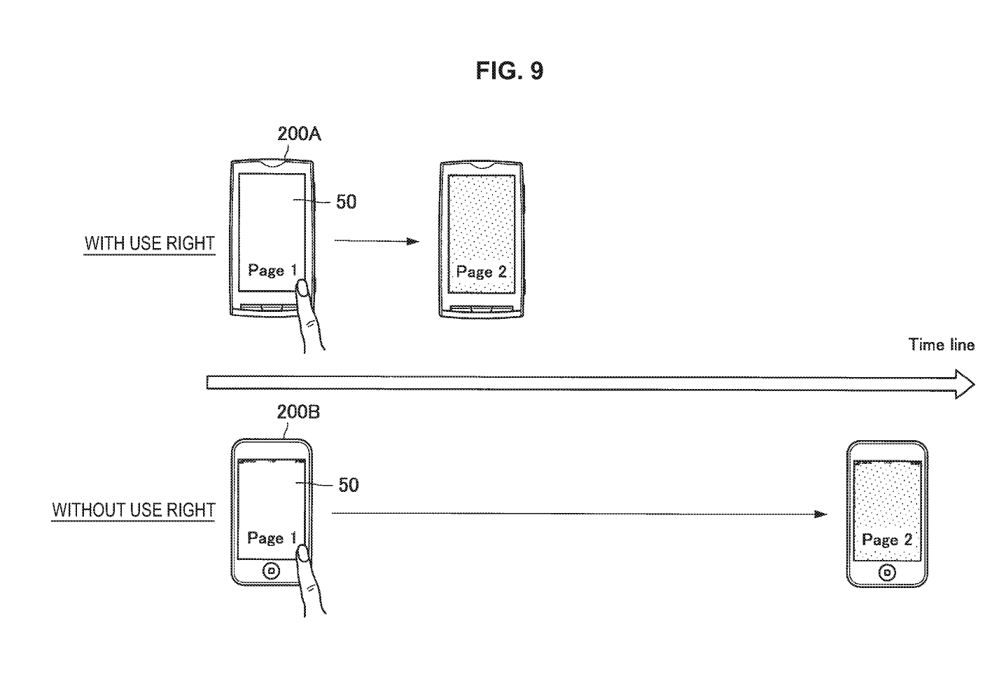

As illustrated in FIG. 9, in the information communication terminal 200A of the user having the use right of electronic book content 50, when the user inputs a page turning operation, a smooth transition from the first page to the second page is made. On the other hand, in the information communication terminal 200B of the user having been provided with the electronic bool content 50 but not having the use right, it is adapted to take a time of, for example, approximately a few seconds by a transition from the first page to the second page is made since the user inputted the page turning operation. As described, it becomes possible for the user not having the use right to also browse the electronic book content although it takes some time.

### (5) Qualitative Restriction (Music Content)

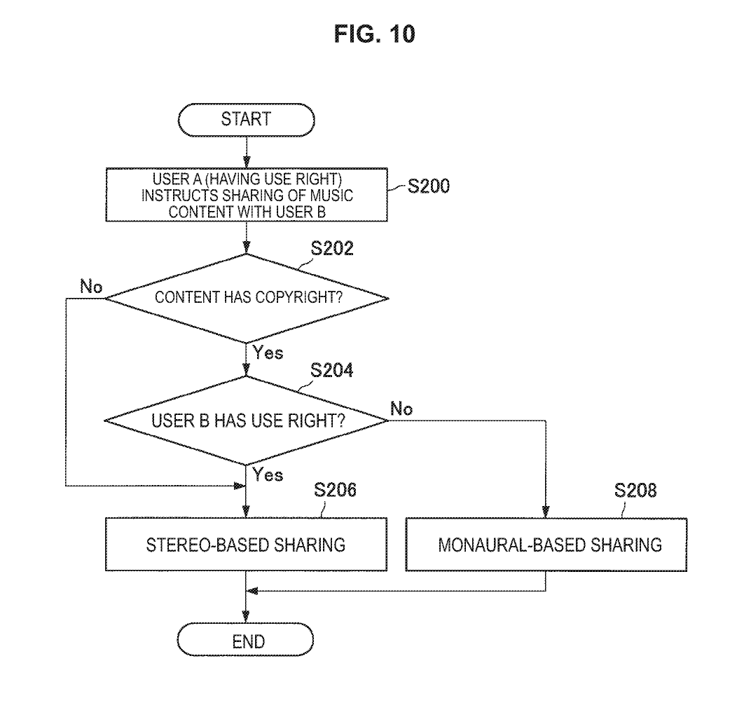

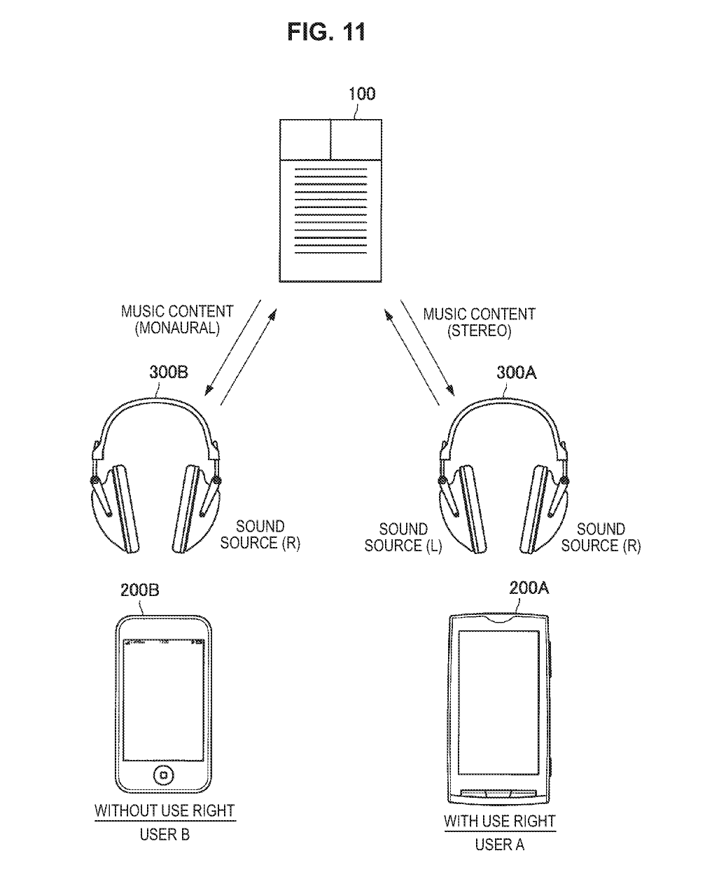

In FIG. 6 and FIG. 7, the examples where qualitative restriction is placed on movie content to provide the movie content to the user not having the use right of the content are illustrated; however, qualitative restriction can also be placed, for example, on music content to provide the music content. FIG. 10 and FIG. 11 illustrate, as an example of qualitative restriction on music content, a process to change a reproduction method.

For example, as illustrated in FIG. 11, it is assumed that the user A having the use right of music content reproduces the music content in the information communication terminal 200A and listens using a headphone 300A. The music content is based on a stereo sound source, and from the headphone 300A of the user A, two sound sources for right and left are outputted.

Now, it is assumed that as illustrated in FIG. 10, the user A instructs sharing of the music content with the user B (S200). On the basis of this instruction, the control part 220 of the information communication terminal 200A first determines whether or not the music content to be shared has a copyright (S202). Then, when it is determined to be copyright-free music content, the control part 220 provides the same stereo sound source as that of the information communication terminal 200A to the information communication terminal 200B of the user B (S206). In this case, the two sound sources for right and left are also outputted from a headphone 300B of the user B.

On the other hand, in Step S202, when the music content to be shared has a copyright, the control part 220 determines whether or not the user B has the use right of the music content (S204). Whether or not the user B has the use right of the music content can be determined on the basis of, for example, content use right presence/absence information managed by an external content management server (not illustrated). When it is determined in Step S204 that the user B has the use right of the music content, the control part 220 provides the same stereo sound source as that of the information communication terminal 200A to the information communication terminal 200B of the user B (S206). In this case, the two sound sources for right and left are also outputted from the headphone 300B of the user B.

When it is determined in Step S204 that the user B does not have the use right of the music content, the content processing part 260 places a use restriction to convert the music content based on the stereo sound source to that based on a monaural sound source (S208). For example, the content processing part 260 performs a process to enable only any one sound source of the two sound sources for right and left on the music content. Then, the control part 220 provides the music content based on the monaural sound source to the information communication terminal 200B of the user B. In doing so, for example, from the headphone 300B of the user B, as illustrated in FIG. 11, only the sound source for right is reproduced. Alternatively, it may be adapted to output the same sound source (e.g., the sound source for right) from both of the right side and the left side of the headphone 300B.

As described, the music content is provided to the user not having the use right of the music content with the qualitative restriction to convert the stereo sound source to the monaural sound source placed. In doing so, the user not having the use right can also use the music content although sound quality is reduced.

In addition, as the qualitative restriction on music content, for example, it is conceivable to reduce a bit rate or an SNR (Signal-Noise Ratio). In this case as well, it becomes possible for a user not having a use right to also use the music content although sound quality is reduced.

As described, the contents of use restriction information can be appropriately set depending on the type of content to be shared or a method for providing content. Accordingly, the above-described contents of use restriction information can also be applied to another type of content. For example, when content to be shared is a game, it can also be adapted to allow a user not having a use right to make use only while a user who has the use right and provides the game content is playing. In addition, it is also possible to combine multiple use restrictions.

Further, even when content to be shared is the same, the contents of use restriction information may be changed depending on a user not having a use right for the sharing. For example, when the content to be shared is music content and provided to a user not having a use right with a bit rate reduced, a level to which the bit rate is reduced may be changed depending on the sharing user. Alternatively, it may be adapted to perform the provision to some user not having the use right with the bit rate reduced and perform the provision to another user not having the use right with an SNR reduced.

Such user-based use restriction information may be set by a user having a use right or automatically set by the content processing part 260 on the basis of a predetermined condition. When doing this, by adapting the use restriction information to be made changeable within a preset use restriction information range, the effects of being able to reduce communication volume and power consumption can also be produced.

Also, as the use restriction information, for example, a restriction to request a user not having a use right to answer a questionnaire and when the user not having the use right answers the questionnaire, provide content to the user not having the use right may be added.

### 2. Second Embodiment

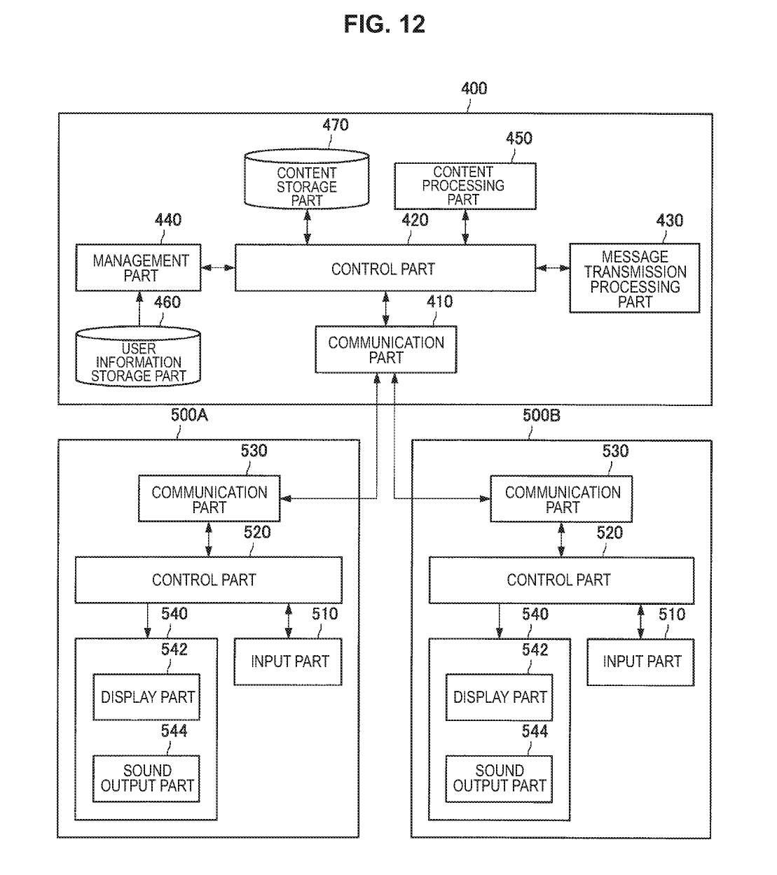

Next, on the basis of FIG. 12, a content sharing system according to a second embodiment of the present disclosure will be described. The content sharing system according to the present embodiment is different as compared with the first embodiment in that a delivery server 400 adapted to transmit/receive messages to/from information communication terminals 500A and 500B also performs a process for content sharing. In the following, the differences from the content sharing system of the first embodiment will be mainly described, and the detailed description of processing parts having the same configuration and function will be omitted.

### [2.1. Functional Configuration]

On the basis of FIG. 12, the functional configuration of the content sharing system according to the present embodiment will be described. FIG. 12 is a functional block diagram illustrating the functional configuration of the content sharing system according to the present embodiment. As illustrated in FIG. 12, the content sharing system according to the present embodiment includes the delivery server 400 adapted to transmit/receive messages and the information communication terminals 500A and 500B. The information communication terminals 500A and 500B are illustrated as terminals respectively used by a user having the use right of content and a user not having the use right of the content, but can be configured to be the same.

### (Delivery Server)

The delivery server 400 is a server adapted to deliver messages to the information communication terminals 500A and 500B connected through a network. In addition, the delivery server 400 also manages content to be shared between the users together with messages, and on the basis of an instruction to share the content between the users, makes a delivery to the information communication terminal 500A or 500B. As illustrated in FIG. 12, the delivery server 400 includes a communication part 410, control part 420, message transmission processing part 430, management part 440, content processing part 450, user information storage part 460, and content storage part 470.

The communication part 410 is an interface adapted to transmit/receive information to/from the information communication terminals 500A and 500B connected through the network. The communication part 410 receives a message to be transmitted from each of the information communication terminals 500A and 500B to a transmission destination, and transmits the message and/or content to an information communication terminal 500A or 500B as the transmission destination.

The control part 420 covers all aspects of control processing of functions of the delivery server 400. The control part 420 transmits a message and/or content on the basis of information received from an information communication terminal 500A or 500B. Also, when sharing content, a process to check whether or not a user to be provided with the content has the use right of the content is made to be performed, or when sharing content with the other user not having the use right of the content, a process to place a use restriction on the content is made to be performed.

The message transmission processing part 430 performs a process to convert a message to be transmitted to a transmission destination into a transmittable form. After having processed the message received from the communication part 410, the message transmission processing part 430 transmits to an information communication terminal 500A or 500B as the transmission destination through the communication part 410.

When sharing content, the management part 440 performs a process to check whether or not a user to be provided with the content has the use right of the content. The management part 440 refers to the below-described user information storage part 460 to check whether or not the user has the use right of the content.

When sharing content between the users, the content processing part 450 performs the process to place a use restriction on the content. When using the content, the other user is adapted by the content processing part 450 to receive a predetermined restriction depending on the type of the content to be provided or a method for providing the content. As described in the first embodiment, use restrictions on content include, for example, a temporal restriction that enables use only at the time of simultaneous use with the user having a use right, a qualitative restriction that reduces the quality of the content, and the like.

When from the user having the use right of content, an instruction to share the content with the other user is issued, the content processing part 450 acquires the content as a target from the content storage part 470, and adds a use restriction to be placed on the content to the content as use restriction information. The content added with the use restriction information is transmitted to the terminal of the other user through the communication part 410.

The user information storage part 460 is a storage part adapted to store pieces of information on the users using a message delivery service in the content sharing system. The user information storage part 460 stores user IDs, pieces of content information that the users have rights to use, and the like. The pieces of information in the user information storage part 460 are referred to by the management part 440, and when sharing content, used to determine whether or not the process to add use restriction information is performed by the content processing part 450.

The content storage part 470 is a storage part adapted to store pieces of content. The pieces of content include pieces of music, photographs, moving images, electronic books, games, and the like. The pieces of content stored in the content storage part 470 can be freely used by the user him-/herself, and also include pieces of content that the other user does not have any right to use. Content stored in the content storage part 470 is processed by the content processing part 450 as necessary and can then be shared with the other user.

### (Information Communication Terminal)

The information communication terminals 500A and 500B are terminals that the users use for transmitting/receiving a message and content, viewing content, or another purpose, and apparatuses such as mobile phones, smartphones, tablet terminals, or wearable terminals. As illustrated in FIG. 12, the information communication terminals 500A and 500B include an input part 510, control part 520, communication part 530, and output part 540. These functional parts can be respectively configured to be the same as the input part 210, control part 220, communication part 230, and output part 250 according to the first embodiment. Detailed description is omitted here.

### [2.2. Content Sharing Process]

In the content sharing system according to the present embodiment, content to be shared between the users is managed by the delivery server 400 as a cloud server. When sharing content between the users, the delivery server 400 performs the process to add use restriction information to the content for the user not having a use right. That is, the same function as that of the information communication terminal 200A adapted to provide content in the first embodiment is provided. As described, the cloud server performs the content sharing process, and can thereby comprehensively manage content without the need to provide each of the information communication terminals 500A and 500B used by the users with a content processing part adapted to add use restriction information.

In this case as well, in the same manner as in the first embodiment, when sharing content between or among multiple users, in particular, when sharing content having access control like a copyright with a user not having the use right of the content, a use restriction is placed to enable the sharing. In doing so, it becomes possible to share the content between or among the multiple users regardless of the use right of the content. Also, by allowing the user not having the use right to use the content with restriction, equity with a user who has paid a consideration to obtain the use right can also be kept

Note that what performs the process based on a use restriction on content delivered by the delivery server 400 may be the delivery server 400 or an information communication terminal 200 to receive the content. In the case where the process based on the use restriction is performed on the content on the delivery server 400 side, the delivery server 400 can reduce the amount of data to be delivered, such as delivering only part of the content.

On the other hand, when it is adapted such that the delivery server 400 directly delivers the content and only the part of the content is used on the basis of the use restriction on the side of the information communication terminal 200 having received the content, it becomes possible to share the content between the users while keeping the absolute amount of the data to be delivered. For example, it is assumed that music content based on a stereo sound source including a sound source L and a sound source R is delivered from the delivery server 400. In this case, the information communication terminals 200 of users A and B not having a use right perform a process such that the information communication terminal 200 of the user A receives only the sound source L and the information communication terminal 200 of the user B receives only the sound source R. Also, for example, when movie content is delivered from the delivery server 400 as well, a process is performed such that, for example, the information communication terminal 200 of the user A not having a use right receives only odd-numbered frames and the information communication terminal 200 of the user B not having a use right receives only even-numbered frames. As described, it may be adapted to, when delivering content, receive parts of the content on the receiving sides respectively even though the content to be delivered by the delivery source is the same.

### 3. Hardware Configuration Example

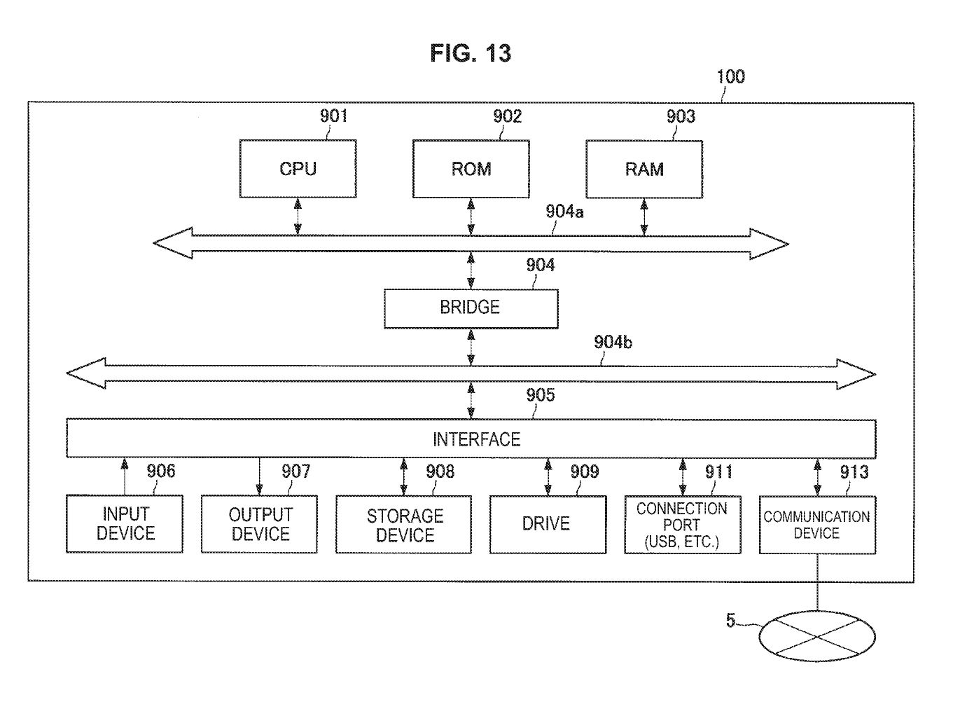

Finally, a hardware configuration example of the delivery servers 100 and 400 and the information communication terminals 200A, 200B, 500A, and 500B according to the above embodiments will be described. These apparatuses can be configured to be the same, and therefore in the following, the description is given taking the delivery server 100 as an example. FIG. 13 is a hardware configuration diagram illustrating the hardware configuration of the delivery server 100 according to the embodiment above.

The delivery server 100 according to the present embodiment can be implemented using a processing device such as a computer as described above. As illustrated in FIG. 13, the delivery server 100 includes a CPU (Central Processing Unit) 901, ROM (Read Only Memory) 902, RAM (Random Access Memory) 903, and host bus 904a. Also, the delivery server 100 includes a bridge 904, external bus 904b, interface 905, input device 906, output device 907, storage device 908, drive 909, connection port 911, and communication device 913

The CPU 901 functions as an arithmetic processing device and a control device, and controls all aspects of actions of the delivery server 100 in accordance with various programs. Also, the CPU 901 may be a microprocessor. The ROM 902 stores a program, operation parameters, and the like to be used by the CPU 901. The RAM 903 temporarily stores a program used to be executed by the CPU 901, parameters appropriately changed when the program is executed, and the like. These are mutually connected through the host bus 904a formed of a CPU bus or the like.

The host bus 904a is connected to the external bus 904b such as a PCI (Peripheral Component Interconnect/Interface) bus through the bridge 904. Note that the host bus 904a, bridge 904, and external bus 904b are not necessarily required to be separately configured, and functions of them may be implemented in one bus.

The input device 906 is configured to include: input means for a user to input information, such as a mouse, keyboard, touch panel, buttons, microphone, switches, and levers; an input control circuit adapted to generate an input signal on the basis of a user's input to output it to the CPU 901; and the like. The output device 907 includes: a display device such as a liquid crystal display (LCD) device, OLED (Organic Light Emitting Diode) device, and a lamp; and a sound output device such as a speaker.

The storage device 908 is an example of a storage part of the delivery server 100, and a device for storing data. The storage device 908 may include: a storage medium; a recording device adapted to record data in the storage medium; a readout device adapted to read out data from the storage medium; a deletion device adapted to delete data recorded in the storage medium; and the like. The storage device 908 drives a hard disk, and stores programs to be executed by the CPU 901 and various types of data

The drive 909 is a reader/writer for the storage medium, and incorporated in or externally attached to the delivery server 100. The drive 909 reads information recorded in an attached removable recording medium such as magnetic disk, optical disk, magnetooptical disk, or semiconductor memory to output it to the RAM 903.

The connection port 911 is an interface to be connected with an external apparatus, and a connection port with an external apparatus that is data transmittable through, for example, a USB (Universal Serial Bus) or the like. Also, the communication device 913 is a communication interface configured to include, for example, a communication device for connecting to a communication network 5, and the like. In addition, the communication device 913 may be a communication device supporting a wireless LAN (Local Area Network), a communication device supporting a wireless USB, or a wired communication device making communication by wire.

The preferred embodiments of the present disclosure have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the configuration of each functional part described in the above embodiments is not limited to the example illustrated in FIG. 2 or FIG. 12. For example, the content processing part, the management part, and the like may be separately provided on the information communication terminal side and on the delivery server side.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing device including:

a processing part adapted to, on a basis of a content sharing instruction from a user having a use right of content provided with the use right, place a use restriction to provide the content to a user not having the use right of the content.

(2)

The information processing device according to (1),

wherein when the content is music, the processing part reduces sound quality to provide the content to the user not having the use right.

(3)

The information processing device according to (1) or (2),

wherein when the content is music based on a stereo sound source, the processing part makes the content monaural to provide the content to the user not having the use right.

(4)

The information processing device according to (3),

wherein when the user not having the use right is provided with the music with use of a device having two or more sound output parts, the processing part makes monaural sound sources outputted from the respective sound output parts same.

(5)

The information processing device according to any one of (1) to (4),

wherein when the content is a moving image, the processing part reduces a frame rate to provide the content to the user not having the use right.

(6)

The information processing device according to any one of (1) to (5),

wherein when the content is a three-dimensional image, the processing part converts the content to a two-dimensional image to provide the content to the user not having the use right.

(7)

The information processing device according to any one of (1) to (6),

wherein when the content is electronic book content, the processing part slows down a page feed speed to provide the content to the user not having the use right.

(8)

The information processing device according to any one of (1) to (7),

wherein the processing part provides the content to the user not having the use right only while the user having the use right is using the content.

(9)

The information processing device according to any one of (1) to (8),

wherein when the user having the use right and the user not having the use right are communicating a message through transmittable/receivable terminals,

on the basis of the content sharing instruction from the user having the use right, the processing part provides the user not having use right of the content with the designated content in a viewable state together with the message.

(10)

The information processing device according to (1),

wherein the processing part adds an advertisement to the content to provide the content to the user not having the use right.

(11)

The information processing device according to (1),

wherein the processing part requests the user not having the use right to answer a questionnaire, and when the user not having the use right answers the questionnaire, the processing part provides the content to the user not having the use right.
(12)

The information processing device according to (1),

wherein when the user having the use right and the user not having the use right are communicating through terminals capable of making a call,

on the basis of the content sharing instruction from the user having the use right, the processing part provides designated music in the content to the user not having the use right of the content as background music for a call.

(13)

The information processing device according to any one of (1) to (12),

wherein upon receipt of an instruction to change a setting of the use restriction from the user having the use right, the processing part changes the use restriction within a use restriction range prescribed in advance by a content delivery source.

(14)

The information processing device according to any one of (1) to (13), including:

a management part adapted to manage a user's use of the content having the use right,

wherein the processing part is configured to, on a basis of a content use right of each of the users, the content use right being determined by the management part, place the use restriction on the content to be provided.

(15)

The information processing device according to any one of (1) to (14),

wherein the information processing device and the content to be provided are provided in a server that is connected through a network to apparatuses used by the users.

(16)

The information processing device according to any one of (1) to (14),

wherein the information processing device is provided in a server that is connected through a network to apparatuses used by the users,

the processing part provides content stored in an apparatus used by the user having the use right to an apparatus used by the user not having the use right through the network.

(17)

An information processing method including:

placing, on a basis of a content sharing instruction from a user having a use right of content provided with the use right, a use restriction to provide the content to a user not having the use right of the content.

(18)

A content sharing system including:

multiple information processing terminals for using content; and

a delivery server adapted to deliver content to the information processing terminals,

wherein on a basis of a content sharing instruction that is received from one of the information processing terminals and is from a user having a use right of content provided with the use right, the delivery server places a use restriction to provide the content to a user not having the use right of the content.

(19)

The content sharing system according to (18),

wherein when there are multiple information processing terminals of users not having a use right of content to be delivered,

the delivery server directly transmits the content to the respective information processing terminals, and

on a basis of the use restriction, each of the information processing terminals receives only a part of the received content.

### REFERENCE SIGNS LIST

100, 400 delivery server
110, 230, 410, 530 communication part
120, 430 message transmission processing part
210, 510 input part
220, 420, 520 control part
240 message processing part
250, 540 output part
252, 542 display part
254, 544 sound output part
260, 450 content processing part
270, 470 content storage part
440 management part
460 user information storage part

1. An information processing device comprising:
a processing part adapted to, on a basis of a content sharing instruction from a user having a use right of content provided with the use right, place a use restriction to provide the content to a user not having the use right of the content.

2. The information processing device according to claim 1,
wherein when the content is music, the processing part reduces sound quality to provide the content to the user not having the use right.

3. The information processing device according to claim 1,
wherein when the content is music based on a stereo sound source, the processing part makes the content monaural to provide the content to the user not having the use right.

4. The information processing device according to claim 3,
wherein when the user not having the use right is provided with the music with use of a device having two or more sound output parts, the processing part makes monaural sound sources outputted from the respective sound output parts same.

5. The information processing device according to claim 1,
wherein when the content is a moving image, the processing part reduces a frame rate to provide the content to the user not having the use right.

6. The information processing device according to claim 1,
wherein when the content is a three-dimensional image, the processing part converts the content to a two-dimensional image to provide the content to the user not having the use right.

7. The information processing device according to claim 1,
wherein when the content is electronic book content, the processing part slows down a page feed speed to provide the content to the user not having the use right.

8. The information processing device according to claim 1,
wherein the processing part provides the content to the user not having the use right only while the user having the use right is using the content.

9. The information processing device according to claim 1,
wherein when the user having the use right and the user not having the use right are communicating a message through transmittable/receivable terminals,
on the basis of the content sharing instruction from the user having the use right, the processing part provides the user not having use right of the content with the designated content in a viewable state together with the message.

10. The information processing device according to claim 1,
wherein the processing part adds an advertisement to the content to provide the content to the user not having the use right.

11. The information processing device according to claim 1,
wherein the processing part requests the user not having the use right to answer a questionnaire, and when the user not having the use right answers the questionnaire, the processing part provides the content to the user not having the use right.

12. The information processing device according to claim 1,
wherein when the user having the use right and the user not having the use right are communicating through terminals capable of making a call,
on the basis of the content sharing instruction from the user having the use right, the processing part provides designated music in the content to the user not having the use right of the content as background music for a call.

13. The information processing device according to claim 1,
wherein upon receipt of an instruction to change a setting of the use restriction from the user having the use right, the processing part changes the use restriction within a use restriction range prescribed in advance by a content delivery source.

14. The information processing device according to claim 1, comprising:
a management part adapted to manage a user's use of the content having the use right,
wherein the processing part is configured to, on a basis of a content use right of each of the users, the content use right being determined by the management part, place the use restriction on the content to be provided.

15. The information processing device according to claim 1,
wherein the information processing device and the content to be provided are provided in a server that is connected through a network to apparatuses used by the users.

16. The information processing device according to claim 1,
wherein the information processing device is provided in a server that is connected through a network to apparatuses used by the users,
the processing part provides content stored in an apparatus used by the user having the use right to an apparatus used by the user not having the use right through the network.

17. An information processing method comprising:
placing, on a basis of a content sharing instruction from a user having a use right of content provided with the use right, a use restriction to provide the content to a user not having the use right of the content.

18. A content sharing system comprising:
multiple information processing terminals for using content; and
a delivery server adapted to deliver content to the information processing terminals,
wherein on a basis of a content sharing instruction that is received from one of the information processing terminals and is from a user having a use right of content provided with the use right, the delivery server places a use restriction to provide the content to a user not having the use right of the content.

19. The content sharing system according to claim 18,
wherein when there are multiple information processing terminals of users not having a use right of content to be delivered,
the delivery server directly transmits the content to the respective information processing terminals, and
on a basis of the use restriction, each of the information processing terminals receives only a part of the received content.
